(19) United States
(12) Patent Application Publication
(10) Pub. No.: US 2006/0192069 A1
(43) Pub. Date: Aug. 31, 2006

(54) Semiconductor equipment support assembly

(75) Inventor: Paul Attaway, Paradise Valley, AZ (US)

Correspondence Address: QUARLES & BRADY LLP, RENAISSANCE ONE, TWO NORTH CENTRAL AVENUE, PHOENIX, AZ, 85004-2391, US

(73) Assignee: True Gravity Enterprises, Inc.

(21) Appl. No.: 11/067,070

(22) Filed: Feb. 25, 2005

(51) Int. Cl. F16B 1/00; E04G 3/00

(52) U.S. Cl. 248/351

(57) ABSTRACT

An adjustable support stand supports equipment above a foundation. A rotatable body has a threaded sleeve. A shaft has a support end for supporting the equipment and a threaded end for screwing into the threaded sleeve of the rotatable body. The rotatable body is coupled to a base. The base of the rotatable body can include a vertical channel member which is adaptable to come in contact with a foundation. The rotatable body is operable to adjust a height of the support stand. An isolation bearing assembly is disposed on the support end of the shaft for providing isolation to the equipment. An optional brace apparatus is connectable to the base of the rotatable body. The brace apparatus can include two or more angled legs to stabilize the rotatable body and clear existing structures and obstacles located on a foundation.

### FIELD OF THE INVENTION

The present invention relates, in general, to equipment support members and, more particularly, to an adjustable support member for semiconductor equipment.

### BACKGROUND OF THE INVENTION

Semiconductor devices are commonly used in the construction of electronic circuits for many types of electronic and consumer products. Integrated circuits and semiconductor devices are manufactured in specially constructed factories using highly customized and proprietary equipment and processes. The small nature of the individual semiconductor components comprising most integrated circuits, the demand for high reliability, and their susceptibility to contamination mandate the use of clean rooms and special manufacturing tools.

The tools and equipment used in the manufacturing of semiconductors can generally be placed in one of two categories: tools that generate vibration and tools that are susceptible to vibrations. Examples of vibration-generating tools include chemical mechanical polishers (CMP) and other rotating or oscillating machinery. Examples of tools that are susceptible to vibration include optical devices such as burning tools and etchers, scanning electron microscopes, and inspection tools.

Semiconductor clean rooms are typically configured with a raised floor constructed with a number of rectangular panels or plates suspended over a concrete base, slab on grade, or other solid foundation. The raised floor provides access to electrical conduits, wiring, piping, ventilation, duct work, and drainage running along and around the foundation. The semiconductor manufacturing tools and other equipment found in clean rooms must be mounted to a table, base plate, stand, or other assembly to support the mass of the tool in a stable and secure manner above the access floor, and to minimize the transfer of any vibrations between sets of equipment. If any vibration originating from rotating machinery should be transferred to vibration-sensitive equipment, then the manufacturing process being performed by such vibration-sensitive equipment could be impaired. For example, many optical burners or etchers are high precision tools operating in the nanometer range. Any vibration in the equipment can jitter or blur the optical focus and create defects in the integrated circuits.

Manufacturing tools are often mounted to tables or plates which are in turn supported by rigid pedestals or “elephant legs”, which are short stands located under each corner or support area of the tool table. The raised flooring is arranged around the equipment support members. An example of a prior art pedestal is shown in FIG. 1. A manufacturing tool 10, such as a CMP found in semiconductor clean rooms, is supported by leveler legs 12 each having foot 14. An adjustable nut 16 turns to lengthen and shorten leg 12 to balance and provide support for manufacturing tool 10.

Another known tool support uses a rigid welded frame assembly to support heavy equipment, e.g., in the range of hundreds to thousands of pounds. The tool support uses a framework of interconnected steel channels which are welded or bolted to the foundation. Each frame assembly is usually custom built to fit in and around existing structures on the foundation, e.g., pipes, conduits, and drains. The frame assembly is heavy, time consuming and expensive to set-up and maintain, and tends to add contaminants to the clean room environment. The rigid construction of the frame assembly makes it difficult and inflexible to move or re-configure with changes in equipment and clean room layout. It is difficult or impossible to quickly and conveniently adjust the height of the frame assembly. If it becomes necessary to move the equipment, substantial planning and re-work to the frame assembly is often needed to meet the foundation slope and drainage requirements and to avoid existing structures and obstacles in the new area. Many times the frame assembly must be completely re-built. Even with careful measurements and planning, unforeseen complications can arise with the many tradespersons co-existing and interfacing in clean room floor access space.

### SUMMARY OF THE INVENTION

In one embodiment, the present invention is a support member for supporting equipment above a foundation, comprising a rotatable body having a threaded sleeve, a shaft having a support end for supporting the equipment and a threaded end for screwing into the threaded sleeve of the rotatable body to adjust a height of the support member, and a base coupled to the rotatable body, wherein the base includes a vertical channel member adaptable to come in contact with the foundation.

In another embodiment, the present invention is a support member for supporting equipment above a foundation, comprising a threaded shaft, a rotatable body having a threaded sleeve adapted to receive the threaded shaft, the rotatable body operable to adjust a height of the threaded shaft, and a base coupled to the rotatable body.

In another embodiment, the present invention is an adjustable height equipment support member, comprising a rotatable body including an extendable shaft threaded into the rotatable body, the rotatable body operable to adjust a height of the extendable shaft, and a base coupled to the rotatable body.

In yet another embodiment, the present invention is a method of making a support member for supporting equipment above a foundation, comprising providing a threaded shaft, providing a rotatable body having a threaded sleeve adapted to receive the threaded shaft, the rotatable body operable to adjust a height of the threaded shaft, and providing a base coupled to the rotatable body.

### BRIEF DESCRIPTION OF THE DRAWINGS

FIG. 1 illustrates a prior art support member for a manufacturing tool;

FIG. 2 illustrates a semiconductor clean room with access floor and support assemblies;

FIGS. 3a-3c illustrate support assemblies supporting a semiconductor manufacturing tool;

FIG. 4 illustrates features of a support assembly;

FIGS. 5a and 5b illustrate an adjustable support subassembly of a support assembly;

FIG. 6a illustrates a cut-out view of an adjustable support subassembly;

FIG. 6b illustrates a cut-out, top view of a bearing mechanism;

FIG. 7 illustrates an adjustable support subassembly coupled to a support post;

FIG. 8 illustrates an example of a support assembly including a brace subassembly;

FIG. 9 illustrates an adjustable support subassembly coupled to a brace subassembly; and

FIGS. 10a and 10b illustrate the isolation bearing assembly connected to an adjustable support subassembly;

### DETAILED DESCRIPTION OF THE DRAWINGS

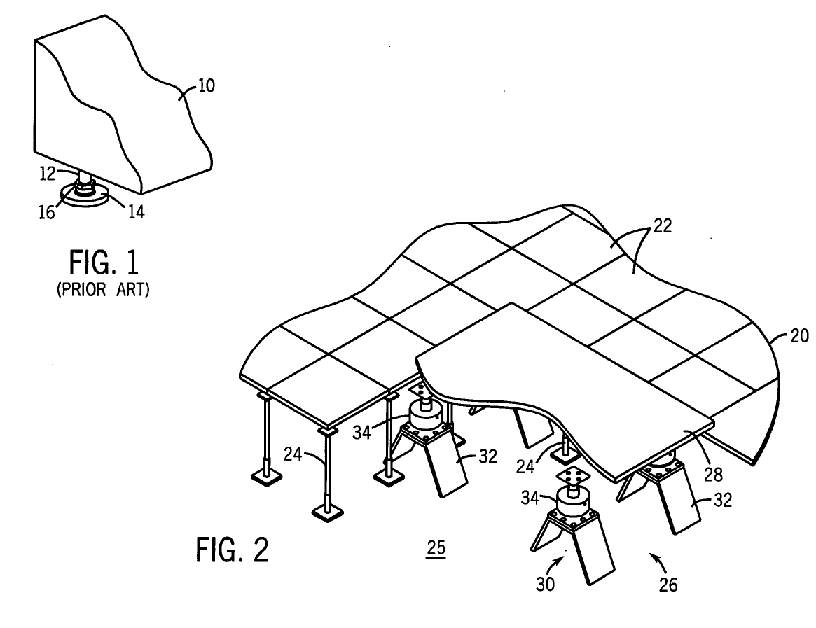

A semiconductor manufacturing clean room area is shown in FIG. 2. An access floor 20 comprises a plurality of rectangular panels or plates 22 supported by stands 24 resting on concrete base, slab on grade, or other solid foundation 25. The plates 22 may be 24-inches square and manufactured from aluminum. Access floor 20 surrounds tool pedestal assembly 26. Tool pedestal assembly 26 includes a base plate or table 28 upon which a semiconductor manufacturing tool or equipment is mounted. Base plate 28 is supported by four support assemblies 30, in contact with foundation 25. Base plate 28 is raised over or flush with adjacent access floor plates 22. Brace 32 serves to anchor adjustable support 34 to the foundation 25. Brace 32 coupled to adjustable support 34 make up an individual support assembly 30.

Support assembly 30 is a load-bearing tool stand or support member suitable for clean room installation in semiconductor facilities for mounting manufacturing tools and other equipment. Support assembly 30 is constructed with clean room compatible materials and protective coatings. Semiconductor manufacturing tools include equipment which are known to generate vibrations such as chemical mechanical polishers (CMP) and other rotating and oscillating machinery, and equipment which are susceptible to vibration such as optical burning tools and etchers, scanning electron microscopes, and inspection tools.

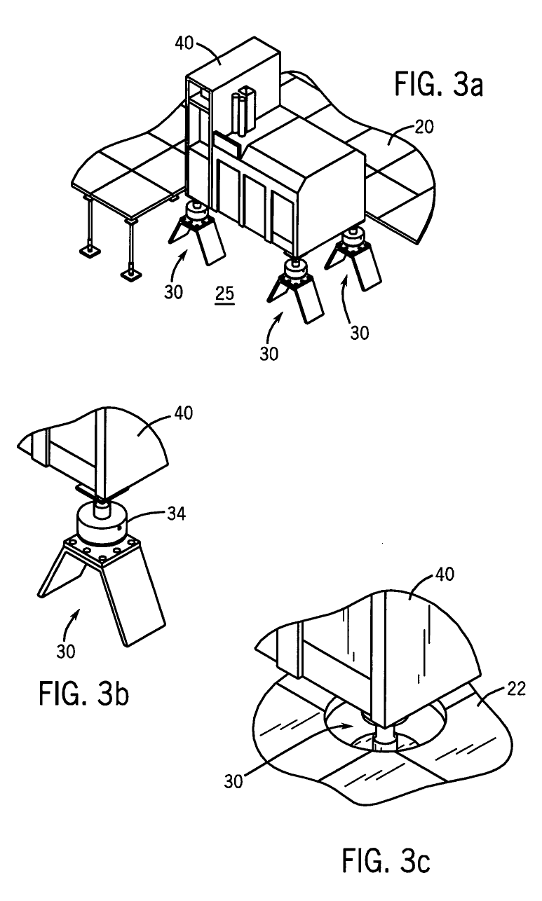

The manufacturing tool can be mounted onto rigid base plate 28 which is supported by one or more support assemblies 30. Alternatively, manufacturing tool or equipment 40 can be directly mounted to one or more support assemblies 30 such as shown in FIG. 3a. Support assemblies 30 are positioned under each corner or other loading surface of manufacturing tool or equipment 40 to maintain the equipment at the desired height above foundation 25. FIG. 3b shows further detail of support assembly 30 supporting one corner of manufacturing tool or equipment 40. The height of adjustable support 34 can be adjusted to that the bottom surface of equipment 40 is positioned below, level with, or above access floor 20. Access floor 20 can easily be placed on all sides of equipment 40 to provide convenient access to the equipment 40. FIG. 3c illustrates equipment 40 positioned above access floor 20 with support assembly 30 extending through a cut-out in one of the access floor plates 22 to support one corner of the equipment 40.

Support assembly 30 is designed and built to accommodate variations in access floor height and slope, leg locations, slant in concrete floor for drainage, trench lines, and to straddle and avoid utility pipes, boxes, conduits, and other fixed structures. Support assembly 30 can be factory or field assembled and can include telescoping ties, braces, struts, cables, and anchorages. Support assembly 30 is rigid, strong, light weight, and can be quickly assembled in the field from easily transportable components. The attachment, fixture, and anchor bolts and other hardware are one size fits all and interchangeable.

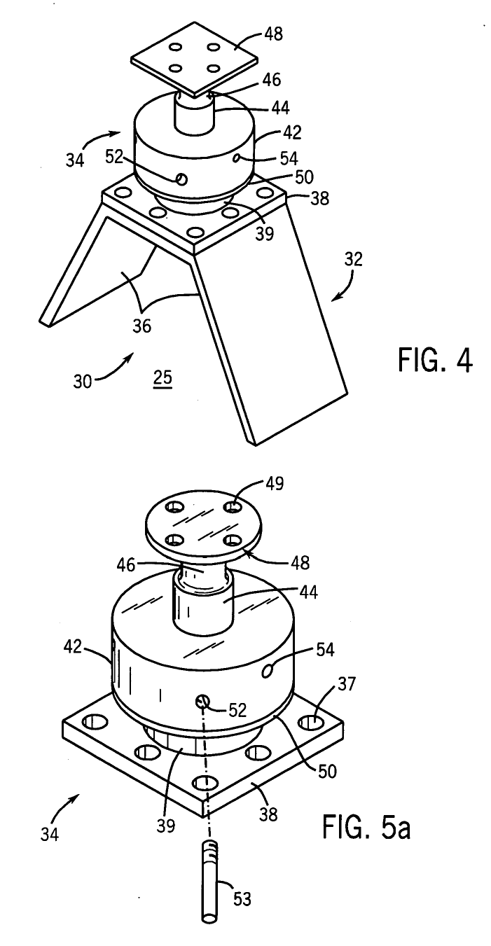

Further detail of support assembly 30 is shown in FIG. 4. Support assembly 30 includes two angled legs 36 which make up a portion of the support structure of brace 32. In other embodiments, support assembly 30 can have three legs 36 or five or more legs 36. Brace 32 can include a variety of structural support assemblies, some of which are discussed below. Legs 36 can include welded steel, aluminum or similar materials. A support assembly 30 is placed under each corner, or other location requiring load support, of base plate 28 and/or equipment 40. Legs 46 are in contact with foundation 25 for a solid base of support. Support assembly 30 can be rotated and oriented so that legs 36 straddle or otherwise avoid any structures and obstacles on and around the foundation. Legs 36 can be positioned over, under, around, or along side existing structures and obstacles such as piping, conduits, ductwork, and drainage.

Adjustable support 34 is shown coupled to brace 32. Adjustable support 34 includes base 38. Base 38 can have a vertical support member 39 which attaches to base 38. Adjustable support 34 includes a rotatable body 42. Rotatable body 42 can have an associated threaded sleeve 44. Threaded sleeve 44 is threaded to accept a shaft 46 which has a threaded end and screws into threaded sleeve 44. Rotatable body is operable by a user to adjust a height of shaft 46. The operation of rotatable body 42 and shaft 46 will be discussed below. Shaft 46 has a support end 48 which is adapted for coming in contact with an end of equipment 40. Support end 48 can include a variety of support structures which enable shaft 46 to securely contact the equipment 40. Rotatable body 42 includes a locking ring assembly 50 to secure rotatable body 42 to vertical support member 39 and in turn, base 38. Rotatable body 42 can include a receptacle 52 which is adapted to receive a removable lever arm. A user can use the lever arm to provide associated torque and thereby turn rotatable body 42. Finally, screw mechanism 54 can allow a set screw or other mechanism to be tightened to prevent rotatable body 42 from turning.

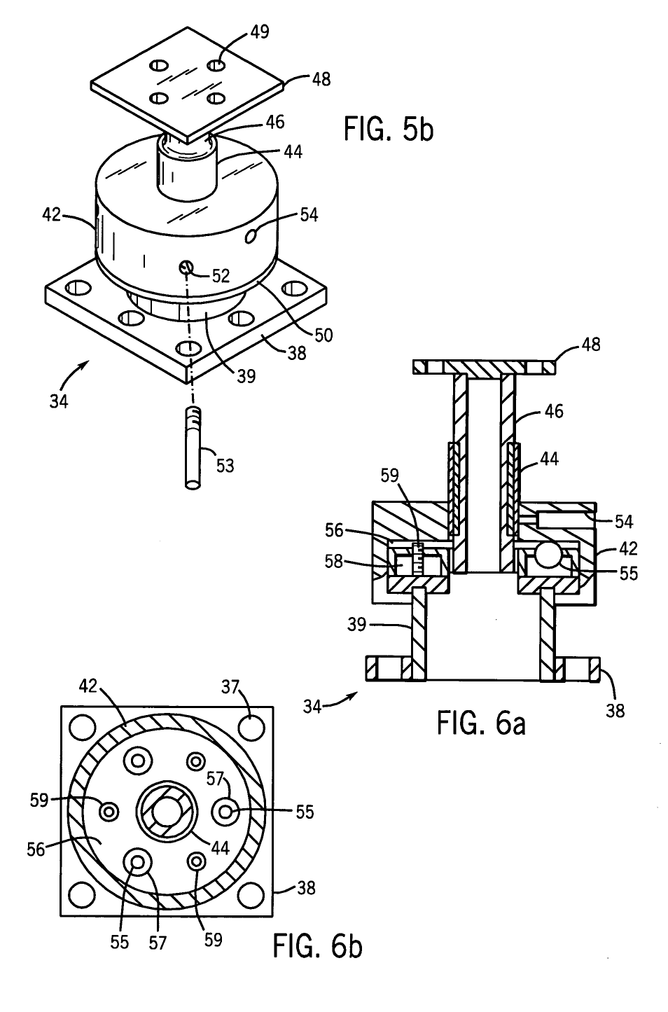

Adjustable support 34 is shown with additional detail in FIG. 5a. Base 38 and associated vertical support member 39 are again shown. Base 38 includes mounting holes 37 which allow bolts to be inserted into base 38. The bolts can be tightened to secure adjustable support 34 to brace 32. Rotatable body 42 is shown again with threaded sleeve 44, shaft 46 and support end 48. Support end 48 includes mounting holes 49 which allow bolts to be inserted into support end 48. The bolts can be tightened to secure adjustable support 42 to the equipment 40. Rotatable body 42 has receptacle 52 for receiving a lever arm 53. Rotatable body 42 is again shown with screw mechanism 54. Screw mechanism 54 can include a set screw which is inserted into rotatable body 42 to hold rotatable body 42 in place and prevent rotatable body 42 from rotating further. Support end 48 as shown is circular, which allows support end 48 to mate with an appropriate receiving portion in equipment 40. Another example of adjustable support 34 is shown in FIG. 5b, which includes substantially the same features as depicted in FIG. 5a. Base 38, support member 39, rotating body 42, sleeve 44, shaft 46, support end 48, mounting holes 49, lock ring 50, receptacle 52, lever arm 53 and screw mechanism 54 are again shown. In FIG. 5b, support end 48 is square-shaped, again allowing support end 48 to mate with an appropriate receiving portion in equipment 40.

Adjustable support 34 is shown in a cut-away form in FIG. 6a. Here again, base 38 is shown coupled to vertical support member 39. Rotating body 42 includes threaded sleeve 44. Shaft 46 is shown with a threaded end. Threads which are integrated in sleeve 44 and shaft 46 are depicted. Shaft 46 is screwed into the threaded sleeve 44. Support end 48 is shown coupled to shaft 46. Screw mechanism 54 is shown here in greater detail. Screw mechanism 54 includes a channel which is adapted for receiving a set screw. A set screw is inserted in the channel, which can have a threaded inner end to match the threads of the set screw. The set screw can be inserted into the threads and rotated to the point where the set screw punctures threaded sleeve 44 and comes into contact with the threaded end of shaft 46. The set screw can be tightened so that the rotatable body can no longer turn and is securely held in place.

Rotatable body 42 is shown including bearing 55. Rotatable body 42 can include a bearing 55 mechanism to reduce friction as the rotatable body 42 is turned. Bearing 55 can be a thrust bearing which is designed to handle axial loads or forces placed upon bearing 55. Bearing 55 mechanism can also serve to reduce vibration and provide further vibration isolation and dampening functions. Rotatable body 42 can oscillate horizontally. By allowing horizontal oscillation to occur in rotating body 42, horizontal vibration can be isolated in rotating body 42 through the use of associated bearing 55 mechanism. Bearing 55 mechanism is held in place inside the housing of rotatable body 42 by screw 59. Additionally, screw 59 can provide the option of securing bearing 55 mechanism against rotatable body 42 to defeat horizontal oscillation and accordingly, horizontal isolation if desired. In effect, rotatable body 42 can be configured along with bearing 55 mechanism to move freely to oscillate and isolate vibration, or it can be configured to be rigid to defeat isolation.

Associated with bearing 55 is bearing guide 56 and bearing track 58 which allows bearing 55 to move with rotatable body 42. Bearing 55 is held in position by bearing guide 56 and moves along bearing track 58. Bearing guide 56 is secured to bearing track 58 with screw 59. Bearing track 58 can be lubricated with a common additive such as ordinary grease, lubricating oil or similar materials.

Bearing 55 mechanism is illustrated in greater detail in a top, cut-out view as shown in FIG. 6b. The housing of rotatable body 42 is seen, surrounded by mounting holes 37 located in base 38. Here, bearing guide 56 is shown covering bearing 55 mechanism. Bearing guide 56 acts as a cover plate, with associated cutouts 57 which are adapted for a bearing 55 to protrude through and accept a load. Cross sections of bearings 55 are shown enclosed by cutouts 57. Screws 59 are shown securing bearing guide 56 down over bearings 55.

As equipment 40 is placed on support end 48, the load from the equipment 40 is transferred down to the threads of shaft 46. The load is then transferred to the matching threads of sleeve 44. The load travels down the threaded sleeve and is displaced through the screw mechanism 44 and throughout the top portion of rotating body 42. The load contacts bearing 55, travels through bearing 55 and down the vertical support member 39 to base 38.

As described previously, a user can turn rotating body 42 to adjust a height of shaft 46, and in turn, the overall height of adjustable support 34. Adjustable support 34 is designed such that rotatable body 42 and sleeve 44 remain in substantially the same position during a height adjustment of shaft 46. As a user turns rotatable body 42, rotatable body rotates around a fixed axis. The rotation, however, causes the threads in sleeve 44 to either work with or against the threads in shaft 46. As a result, the rotatable body 42 stays in substantially the same position, but shaft 46 is either moved upwards or downwards relative to sleeve 44. The threaded features of sleeve 44 and shaft 46 allow adjustable support 34 to lift, lower, level and align practically any manufacturing tool. In one embodiment, an adjustable support 34 weighing about 100 lbs can support a load of up to 8000 lbs. In one example, the threads integrated into shaft 46 and sleeve 44 can be finely spaced, so that rotatable body 42 must rotate further in order to raise or lower a height of shaft 46. Requiring rotatable body 42 to rotate additional turns through the use of finer threads can reduce the amount of torque necessary to raise shaft 46. In one example, the threads are square-profiled, low pitch, and Teflon-coated for ease of lifting under high load. The threads integrated into shaft 46 and sleeve 44 make adjustable support 34 adjustable in height to accommodate any distance or clearance between foundation 25 and manufacturing tool or equipment 40.

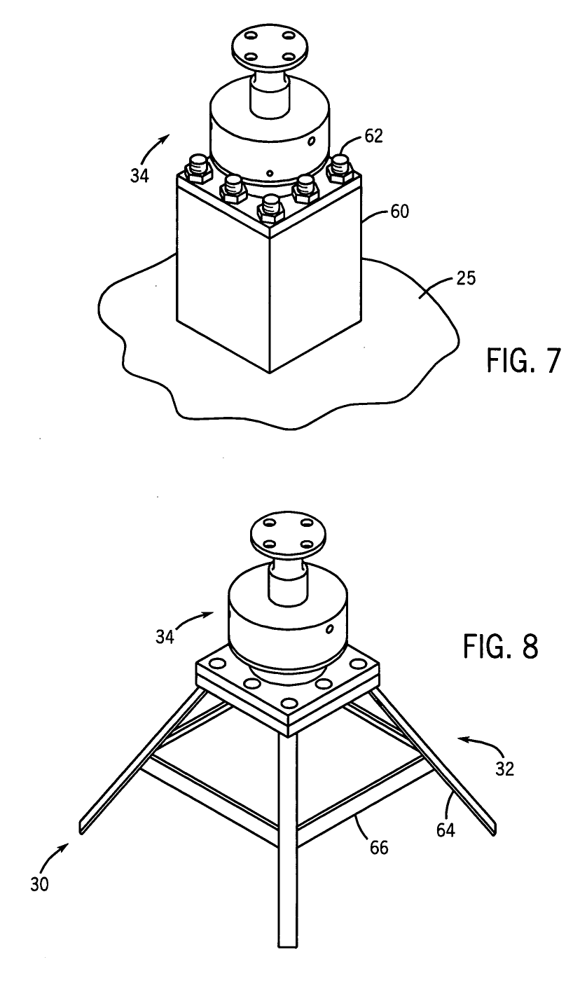

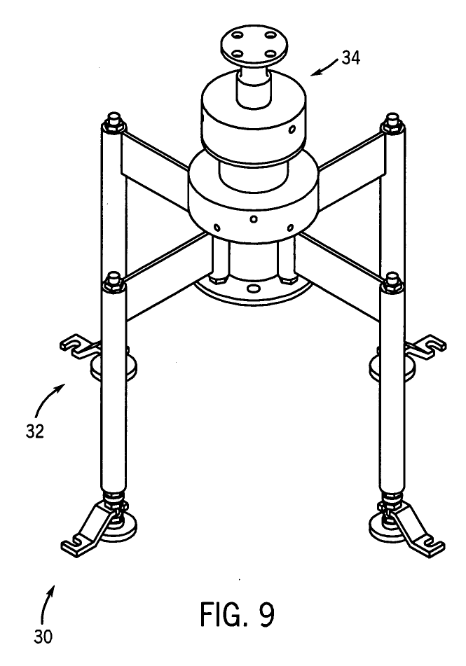

FIGS. 7-9 illustrate an adjustable support 34 in a variety of settings. As mentioned previously, adjustable support 34 can be used independently of a brace 32 or it can use a variety of braces 32 or other support mechanisms. FIG. 7 depicts adjustable support 34 coupled to a support post 60 which contacts foundation 25 at the base of post 60. Post 60 is connected to adjustable support 34 using bolts 62. FIG. 8 illustrates a support assembly 30 which includes an adjustable support 34 coupled to a brace 32. In the depicted example, brace 32 includes four legs 64 which are held in place with cross supports 66. FIG. 9 illustrates a support assembly 30 which includes an adjustable support 34 coupled to a brace 32.

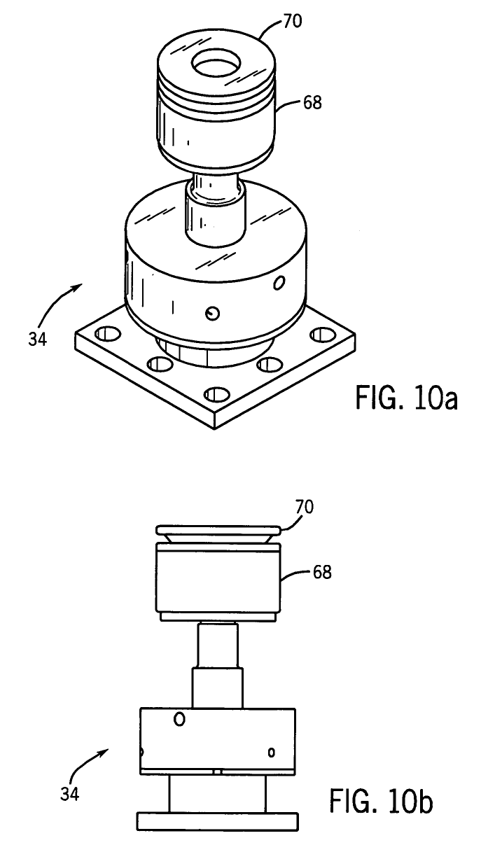

FIGS. 10a and 10b illustrate an adjustable support 34 with optional isolation bearing assembly 68 having a swivel head 70 to support equipment 40. Isolation bearing assembly 68 provides a strong, long stroke vibration isolation feature for adjustable support 34. Isolation bearing assembly 68 can provide vertical vibration isolation to support equipment 40. The top portion of head 70 swivels independent of isolation bearing assembly 68 to provide rotational freedom and ease of installation and operation in lifting and leveling manufacturing tool or equipment 40. FIG. 10b shows a side view of adjustable support 34 with isolation bearing assembly 68 and swivel head 70.

In an alternate embodiment, an electric motor can be used to turn rotatable body 42 and adjust the height of adjustable support 34.

As illustrated in the preceding figures, support assembly 30 is modularly constructed with interchangeable components. This feature allows support assembly 30 to be easily adapted to the loading requirements, spacing, structures, obstacles, and surface orientation of foundation 25. Support assembly 30 can be placed in and around many existing structures and obstacles while accounting for variation in evenness and level of the foundation surface. Support assembly 30 can then be adjusted to a wide range of heights to match the clearance requirement for equipment 40 above foundation 25. Support assembly 30 supports equipment 40 is a variety of environments and conditions. Support assembly 30 is easily taken down and moveable to setup and support other equipment.

Support assembly 30 has many other applications. Support assembly 30 could be used in construction, remodeling, and any other area where there is a need to support an object. Support assembly 30 provides a convenient and cost effective alternative to fixed frame assemblies and can be adapted to fit in and around the existing environment.

The present invention has been described with respect to preferred embodiment(s). Any person skilled in the art will recognize that changes can be made in form and detail, and equivalents may be substituted for elements of the invention without departing from the spirit and scope of the invention. Many modifications may be made to adapt to a particular situation or material to the teaching of the invention without departing from the essential scope of the invention. Therefore, it is intended that the invention not be limited to the particular embodiments disclosed for carrying out this invention, but that the invention will include all embodiments falling within the scope of the following claims.

What is claimed is:

1. A support member for supporting equipment above a foundation, comprising:
a rotatable body having a threaded sleeve;
a shaft having a support end for supporting the equipment and a threaded end for screwing into the threaded sleeve of the rotatable body to adjust a height of the support member; and
a base coupled to the rotatable body, wherein the base includes a vertical channel member adaptable to come in contact with the foundation.

2. The support member of claim 1, wherein the rotatable body further includes a bearing assembly to reduce friction.

3. The support member of claim 1, wherein the rotatable body further includes a screw mechanism to hold the rotatable body in place.

4. The support member of claim 1, wherein the rotatable body further includes a locking ring assembly to secure the rotatable body to the base.

5. The support member of claim 1 further including an isolation bearing assembly disposed on the support end of the shaft for providing isolation to the equipment.

6. The support member of claim 5 wherein the isolation bearing assembly includes a swivel head for supporting the equipment with free rotation.

7. The support member of claim 1 further including a removable lever arm adaptable to connect to the rotatable body for rotating the rotatable body.

8. A support member for supporting equipment above a foundation, comprising:
a threaded shaft;
a rotatable body having a threaded sleeve adapted to receive the threaded shaft, the rotatable body operable to adjust a height of the threaded shaft; and
a base coupled to the rotatable body.

9. The support member of claim 8, wherein the rotatable body further includes a bearing assembly to reduce friction.

10. The support member of claim 8, wherein the rotatable body further includes a screw mechanism to hold the rotatable body in place.

11. The support member of claim 8, wherein the rotatable body further includes a locking ring assembly to secure the rotatable body to the base.

12. The support member of claim 8 further including an isolation bearing assembly disposed on one end of the threaded shaft for providing isolation to the equipment.

13. An adjustable height equipment support member, comprising:
a rotatable body including an extendable shaft threaded into the rotatable body, the rotatable body operable to adjust a height of the extendable shaft; and
a base coupled to the rotatable body.

14. The adjustable height equipment support member of claim 13, wherein the rotatable body further includes a bearing assembly to reduce friction.

15. The adjustable height equipment support member of claim 13, wherein the rotatable body further includes a screw mechanism to hold the rotatable body in place.

16. The adjustable height equipment support stand of claim 13 further including an isolation bearing assembly disposed on one end of the extendable shaft for providing isolation to the equipment.

17. The adjustable height equipment support stand of claim 16 wherein the isolation bearing assembly includes a swivel head with free rotation.

18. A method of making a support member for supporting equipment above a foundation, comprising:
providing a threaded shaft;
providing a rotatable body having a threaded sleeve adapted to receive the threaded shaft, the rotatable body operable to adjust a height of the threaded shaft; and
providing a base coupled to the rotatable body.

19. The method of making a support member of claim 18, wherein providing a rotatable body further includes providing a ball bearing apparatus integrated in the rotatable body for reducing friction.

20. The method of making a support member of claim 18, wherein providing a threaded shaft further includes providing an isolation bearing assembly disposed on an end of the threaded shaft to provide isolation to the equipment.

21. The method of making a support member of claim 18, wherein providing a rotatable body further includes providing a removable lever arm adaptable to connect to the rotatable body for rotating the rotatable body.
